(19) United States
(12) Patent Application Publication
(10) Pub. No.: US 2008/0091359 A1
(43) Pub. Date: Apr. 17, 2008

(54) Normalizing spectroscopy data with multiple internal standards

(75) Inventor: Matej Oresic, Espoo (FI)

Correspondence Address: YOUNG & THOMPSON, 745 SOUTH 23RD STREET, 2ND FLOOR, ARLINGTON, VA, 22202, US

(73) Assignee: VALTION TEKNILLINEN TUTKIMUSKESKUS, ESPOO (FI)

(21) Appl. No.: 11/812,126

(22) Filed: Jun. 15, 2007

(30) Foreign Application Priority Data
Jun. 21, 2006 (FI) 20065430

(51) Int. Cl. G06F 19/00; G01N 30/02; G01N 30/72

(52) U.S. Cl. 702/27

(57) ABSTRACT

Normalization of spectra, including: preparing experiment runs; processing them in an LC/MS spectrometer to obtain a spectrum for each experiment run; internally representing each spectrum as mass/charge (m/z) versus retention time (rt); performing a peak detection of each spectrum; internally aligning the detected peaks; and normalizing the spectra, which includes modelling variation of Yᵢⱼ, denoted δYᵢⱼ, as a function of variability of Ω, denoted f(δΩ). δ denotes variability of a quantity, (the quantity's deviation from an average value of the quantity over the sample runs); X=Xᵢⱼ=intensity matrix for all peaks, mapped to Y via a first transformation function f such that Y=f⁻¹(X); Z=Zᵢⱼ=intensity matrix for internal standard peaks (IS₁-IS₄), mapped to Ω via a second transformation function t such that Ω=t⁻¹ (Z). i denotes peaks: i→{m/z, rt} and i=1 . . . N; and j denotes experiment runs.

### FIELD OF THE INVENTION

The invention relates to methods and equipment for normalizing spectroscopy data, particularly metabolomics data, by multiple internal standards. Particularly, the invention relates to forming an optimal selection of the multiple internal standards. As used herein, an internal standard compound means a standard compound which is added to a sample prior to extraction, while an external standard compound means a standard compound which is added to the sample after extraction.

### BACKGROUND OF THE INVENTION

Metabolomics is a discipline dedicated to the global study of metabolites, their dynamics, composition, interactions, and responses to interventions or to changes in their environment, in cells, tissues, and biofluids. Concentration changes of specific groups of metabolites may be descriptive of systems' responses to environmental or genetic interventions, and their study may therefore be a powerful tool for characterization of complex phenotypes as well as for development of biomarkers for specific physiological responses.

Study of the variability of metabolites in different states of biological systems is therefore an important task in systems biology. Because researches' principal interest is in system responses which result in metabolite level regulation in relation to diverse genetic or environmental changes, it is important to separate such interesting biological variation from obscuring sources of variability introduced in experimental studies of metabolites. Since multiple experimental platforms are commonly applied in the study of metabolites, the sources of the obscuring variation are many and platform-specific. Such sources may include variation in sample preparation and metabolite extraction, which are affected by primary sample handling such as quenching, pipetting error, reagent quality or temperature. In mass spectrometry-based detection, the sources include the variations in the ion source as well as biological sample-specific effects such as ion suppression. Following the measurement, the data pre-processing steps, such as peak detection and alignment, may introduce additional errors.

Chemical diversity of metabolites, which may, for example, lead to different recoveries during extraction and responses during ionization in a mass spectrometer, hampers the task of separating interesting variations from obscuring ones. Quantitative analytical methods have commonly relied on utilization of isotope-labelled internal standard for each metabolite measured. However, in broad metabolic profiling approaches this is not practical, since the number of metabolites is very high. Their chemical diversity is too high for a common labelling approach, and many of the metabolites may not even be known.

Currently applied approaches for normalization of metabolic profile data can be divided into two major categories. A first category includes statistical models used to derive optimal scaling factors for each sample on the basis of a complete dataset, such as normalization by sum of squares of intensities or maximum likelihood method adopted from the approach developed for gene expression data. A second category includes normalization techniques by one or more internal or external standard compounds on the basis of empirical rules, such as specific regions of retention time, or distance to the metabolite peaks in the spectra.

The statistical approach suffers from a lack of an absolute concentration reference for different metabolites. Metabolites as physiological end-points, largely affected by the environment, do not posses the self-averaging property. In other words, a concentration increase in a specific group of metabolites is generally not balanced by a decrease in another group. FIG. 9, which illustrates this point, shows total ion chromatograms from HPLC-MS lipidomics profiling of two different mouse liver samples, one from an obese ob/ob mouse model, the other from a lean wild type mouse. Both mice have similar levels of phospholipids, but the amount of storage fat in the form of triacylglycerols is markedly increased in the obese mouse. If one would normalize this data on the basis of total signal, such an approach would lead to the conclusion that the phospholipids are decreased in the obese mouse (wrong conclusion), while the triacylglycerols are slightly increased (correct qualitatively, but not quantitatively). While more sophisticated approaches to normalize metabolomics data based on full profile data have been adopted, the fundamental problem as described above remains.

The choice of multiple internal and external standard compounds may be a more reasonable choice, but even in that case the assignment of the standards to normalize specific peaks remains unclear. One possible approach is to assign a specific standard to metabolite peaks based on similarity in specific chemical property such as retention time in liquid chromatography (LC) column. For example, Bijisma and colleagues utilize three external standard references for lipid profiling, chosen as mono-, di-, and tri-acyl lipid species representing most common lipid classes in their respective region of retention time. Such approach still suffers from at least two problems. First, the retention time is not necessarily descriptive of all matrix and chemical properties leading to obscuring variation. For example, in the lipid separation based on reverse phase LC diverse lipid species such as ceramides, sphingomyelins, diacylglycerols, and several phsopholipid classes, are overlapping in retention time, and it is not reasonable to assume same normalization factor can be applied to all these species. The situation is even more complex when analyzing water soluble metabolites. Second, the normalization by a single molecular component is at best as good as the quality of the measurement of that specific component. Therefore, such methods are very sensitive to obscuring variation of individual standard compounds. This becomes a problem in very complex samples where matrix-specific effects such as ion suppression may play an important role.

### BRIEF DESCRIPTION OF THE INVENTION

An object of the invention is to develop methods and equipment which alleviate some or all of the problem described above. Particularly, it is an object of the invention to improve the ability of spectrometer analysis equipment to distinguish between relevant and obscuring variations. This is accomplished by a novel normalization method which diminishes effects of systematic variation within the spectra.

Specifically, the object of the invention is achieved with methods, equipment and software products which are characterized by the appended independent claims. The dependent claims relate to specific embodiments of the invention.

An aspect of the invention is a method for normalizing a plurality of spectra, the method comprising:
preparing a plurality of experiment runs;
processing each of the prepared experiment runs in an LC/MS spectrometer to obtain a spectrum in respect of each processed experiment run;
internally representing each spectrum as a layout of mass/charge versus retention time;
performing a peak detection to detect peaks of each spectrum;
internally aligning the detected peaks of each spectrum; and
normalizing the plurality of spectra, wherein the normalizing comprises modelling variation of Yᵢⱼ, denoted δYᵢⱼ, as a function of variability of Ω, denoted ƒ(δΩ).

Herein:
denotes variability of a quantity, wherein the variability is a measure of the quantity's deviation from an average value of the quantity over the sample runs;
X=Xᵢⱼ=intensity matrix for all peaks and X is mapped to Y via a first data transformation function f such that Y=f−1(X);
Z=Zᵢⱼ=intensity matrix for internal standard peaks and Z is mapped to Ω via a second data transformation function t such that Ω=t−1(Z);
i denotes peaks: i→{m/z, rt} and i=1 . . . N;
j denotes experiment runs.

Another aspect of the invention is a data processing system for normalizing spectroscopy data by the method according to the invention. Yet Another aspect of the invention is a program product the execution of which causes a data processor to carry out the normalization method according to the invention.

The first and second data transformation function ƒ, t may be similar of different data transformation functions. For instance, if the first data transformation functions ƒ is logarithm (X=log(Y)), then Y=antilog(X).

In the following description, the acronym “NOMIS”, which stands for NOrmalization with Multiple Internal Standards, denotes the technique according to the invention. The NOMIS technique can be used directly as a one-step normalization method, or as a two-step method where the normalization parameters containing information about the variabilities of internal standard compounds and their association to variabilities of metabolites are first calculated from a repeatability study. Additionally, the technique can be used to select standard compounds for normalization and evaluate their influence on variability of metabolites across the full spectrum.

In one specific embodiment, the inventive method is formally expressed as follows. The non-normalized metabolomics data resulting from first stages of pre-processing, which usually include peak detection and alignment, can be represented by a matrix of N variables (metabolite peaks) and M objects (samples). For example, in liquid chromatography/mass spectrometry-based (LC/MS) profiling, each peak is represented by mass to charge ratio (m/z) and retention time (rt). The following notation will be used:
i parameterizes peaks: i→{m/z, rt} and i=1 . . . N.
s parameterizes peaks from internal standard compounds: s→{m/z,rt} and s=1 . . . S.
j parameterizes experiment runs: j=1 . . . M.
Intensity matrix for all peaks: X={Xᵢⱼ}.
Intensity matrix for all internal standard peaks: Z={Zₛⱼ}.

Most of the errors described above depend on intensity or metabolite concentration. Therefore, it is reasonable to assume that the true metabolite levels are modified by a multiplicative correction factor. Formally:
Xᵢⱼ=mᵢ×rᵢⱼ({Zₛⱼ})×eᵢⱼ, [11]

Herein, mⱼ is the actual intensity value, ie, an intensity value independent of the run, rᵢⱼ is the correction factor, and eᵢⱼ is the random error. In one implementation of the invention, the systematic variation in each individual metabolite Xᵢ is modelled as a function of variation of standard compounds, as illustrated in FIG. 2. Based on this assumption, the correction factors rᵢⱼ can be determined from the profiles of standard compounds.

Because the error model is assumed multiplicative, it is appropriate to work in a logarithmic space. In other words, the logarithm function is a good candidate for the first and second data transformation functions, because a logarithmic transformation changes a multiplicative model to an additive one.
log X→Y, log Z→Ω, log m→μ, log r→ρ, log e→ε [2]

Assuming logarithmic data transformation, the model is additive:
Yᵢⱼ=μᵢⱼ+ρᵢⱼ(Ωⱼ)+εᵢⱼ [3]

In one specific implementation, the random error e is assumed Gaussian with a zero mean and independent variables:
e˜N(0,{σᵢ²}). [4]

The variable ρ (logarithm of the correction factor) can be parameterized as a linear function of internal standard variation:

$${ρ}_{ij} = {\sum }_{s} {β}_{is} ( {Ω}_{sj} - 〈 {Ω}_{s .} 〉 ) . \qquad [ 5 ]$$

Herein, the parameters β control how the variability of internal standard intensities affect the variability of intensities of other metabolite peaks. It is clear from the above equations that Yᵢⱼ is normally distributed:
Yᵢⱼ˜N(μᵢ+ρᵢⱼ,{σᵢ²}), [6]

Accordingly, the likelihood of observing data Y under the assumption of normality is:

$$L = log ( {\prod }_{ij} P ( {Y}_{ij} \vert {μ}_{i} , {ρ}_{ij} , {ɛ}_{ij} ) ) = - \frac{1}{2} {\sum }_{ij} ( log ( 2 π {σ}_{i}^{2 } ) + \frac{{( {Y}_{ij} - {μ}_{i} - {\sum }_{s} {β}_{is} ( {Ω}_{sj} - 〈 {Ω}_{s .} 〉 ) )}^{2}}{{σ}_{i}^{2 }} ) . \qquad [ 7 ]$$

Omitting a straightforward derivation, maximizing the (log)likelihood of observing the data leads to the following solutions
μᵢ= [symbol] Yᵢ [symbol] [8]
and
βΣ×\hat{Σ}⁻¹, [9]

Herein,

$${\sum }_{is} = {\sum }_{j} ( {Y}_{ij} - 〈 {Y}_{i .} 〉 ) ( {Ω}_{sj} - 〈 {Ω}_{s .} 〉 ) \qquad [ 10 ]$$

correlates the internal standards and other peaks, and

$${\hat{\sum }}_{st} = {\sum }_{j} ( {Ω}_{sj} - 〈 {Ω}_{s .} 〉 ) ( {Ω}_{tj} - 〈 {Ω}_{t .} 〉 ) \qquad [ 11 ]$$

is a covariance matrix for internal standards.

Based on the multiplicative error model from Equation [1], the normalization factors for each peak can be calculated as:

$${\tilde{X}}_{ij} = {X}_{ij} \times exp ( - {\sum }_{s} {β}_{is} ( {Ω}_{sj} - 〈 {Ω}_{s .} 〉 ) ) , \qquad [ 12 ]$$

Herein, Ω can be obtained from the profiles of identified internal standards found in the spectra, and the parameters β can be calculated from equation [9].

Since the matrix β relates the variability of each individual metabolite in biological matrix with that of internal standards for a specific platform and biological matrix, it is possible that the parameters β are obtained from a separate repeatability experiment involving a large number of repeated measurements. This may often be desirable due to the large number of normalization parameters (N×S) to be determined by the inventive technique. The correction factors from equation [12] in a real biological application then include the matrix β obtained independently as well as the measured levels of internal standards {Ωₛⱼ} from the biological experiment.

A technical benefit of the inventive normalization technique is improved spectroscopy analysis because the effect of systematic variation is diminished.

Those skilled in the art will realize that the use of the logarithm function as the data transformation functions simplifies the description of the inventive normalization method. It also simplifies calculations to computers. However, the invention is not restricted to the use of the logarithm function, and a large variety of data transformation functions can be used.

### BRIEF DESCRIPTION OF THE DRAWINGS

In the following the invention will be described in greater detail by means of specific embodiments with reference to the attached drawings, in which

FIG. 1 shows an overall view of a spectroscopy measurement;

FIG. 2 illustrates an operating principle of the inventive normalization method;

FIG. 3 shows a coefficient of variance distributions for different normalization methods;

FIG. 4 shows coefficients of variance for individual peaks in a liver repeatability study;

FIG. 5 shows an internal standard profile upon its addition to a raw dataset;

FIG. 6 illustrates the inventive method as a tool to select the best set of internal standards used for normalization;

FIG. 7 shows the beta (β) matrix values for selected liver lipid components;

FIG. 8 shows coefficients of variance for identified liver lipid species; and

FIG. 9, which was described earlier, in the background section of this application, shows a comparison of two metabolomic total ion chromatograms (TIC) from two different mouse phenotypes.

### DETAILED DESCRIPTION OF SPECIFIC EMBODIMENTS

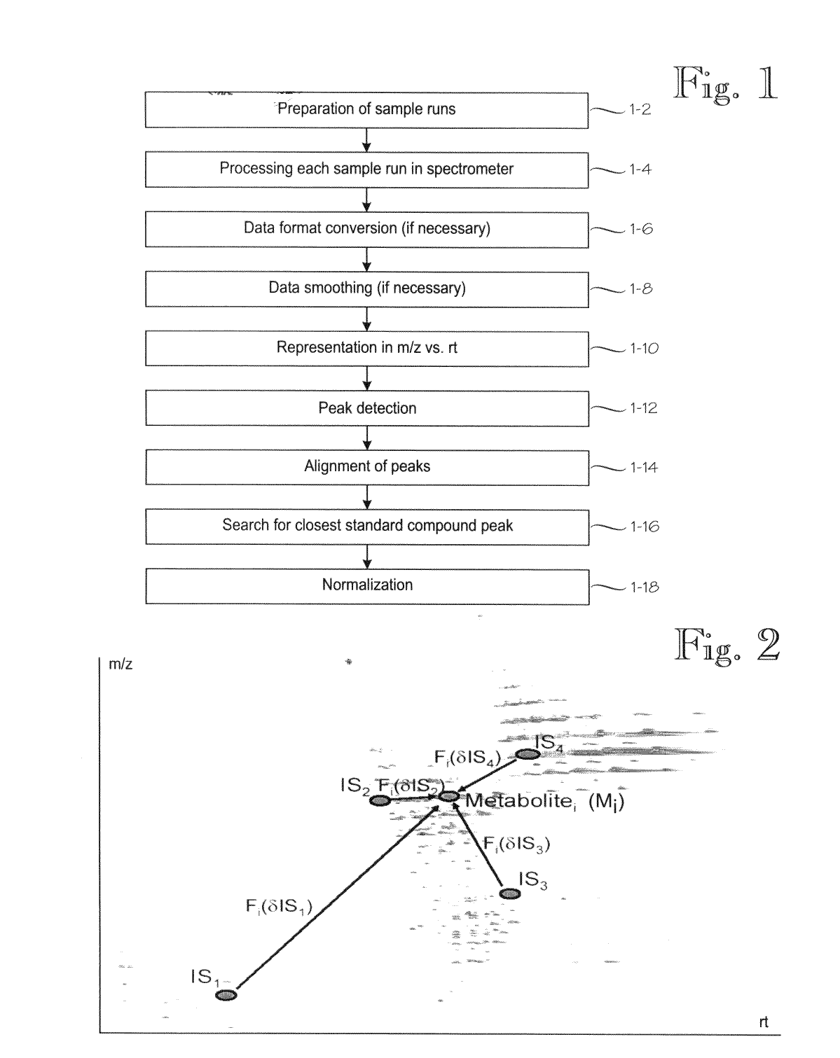

FIG. 1 is a flow chart illustrating main phases in a method according to an embodiment of the invention. The invention relates to processing of spectral data from a plurality of sample runs. Each sample run produces a spectrum (spectral data) from a sample. The samples used in the different sample runs can be subsamples from a common larger sample, or they can derive from different samples altogether.

Reference numeral 1-2 denotes sample preparation steps which are known to those skilled in the art and which have been briefly discussed in the background section of this document. Reference numeral 1-4 denotes a step which comprises spectrometry operations, including recording of measured spectral data. Reference numeral 1-6 denotes an optional step in which the spectral data is converted from a vendor-specific data format to some open data format, such as netCDF. A benefit of this step, or the corresponding routine and data structures in the software product, is the ability to support a wide variety of spectrometry instruments. In a further optional step 1-8 the spectral data is smoothed to suppress noise and other spurious data. In some implementations this step may be performed by the spectrometer itself. In step 1-10 the spectral data is internally represented in two dimensions, wherein one dimension corresponds to mass-charge ratio m/z, while the other dimension corresponds to retention time rt. The term ‘internal representation’ means that a visualization of the spectral data is not necessary, at least not at this stage. Reference numeral 1-12 denotes a peak detection step in which peaks in the spectral data are detected.

Steps 1-2 through 1-12 are known to those skilled in the art and a detailed description is omitted for brevity. In these steps the several sample runs are typically processed serially, each sample run at a time. In the following steps the several sample runs are processed in parallel, interdependently.

In step 1-14 data from the several sample runs are aligned such that there is a maximal correspondence between the peaks of the spectra. The verb ‘align’ may imply visualization, but visualization is not strictly necessary, and any equivalent data processing technique may be used. The alignment operation searches for corresponding peaks across different mass spectrometry runs. Peaks from the same compound usually match closely in m/z values, but retention time between the runs may vary. The retention time largely depends on the analytical method used.

After completion of the alignment process, it is likely that the master peak list has some empty gaps, because it is not certain that every peak is detected and aligned in every sample run. The need to deal with these missing values often complicates further statistical analyses, and for this reason, a method according to the invention comprises a second peak detection step 1-16, the purpose of which is to fill these gaps. In one implementation, the second peak detection step employs the m/zₘ and rtₘ values for estimating locations in which the missing peaks can be expected. A search is then conducted to find the highest local maximum over a range around the expected location in the raw spectral data. The search is performed over a search window which is preferably user-settable.

Step 1-18 relates to a normalization step which is further described in connection with FIG. 2 and the above-described equations.

FIG. 2 illustrates an operating principle of the inventive normalization method. As usual, “m/z” stands for mass-to-charge ratio and “rt” denotes retention time. FIG. 2 illustrates how the normalization factors Fᵢ(δIS₁), Fᵢ(δIS₄) for each metabolite peak Mᵢ are influenced by the variability of each internal or external standard component and its association with the variability of the metabolite. In FIG. 2, the standard components are shown as internal standard components IS₁, . . . , IS₄.

### Performance Examples

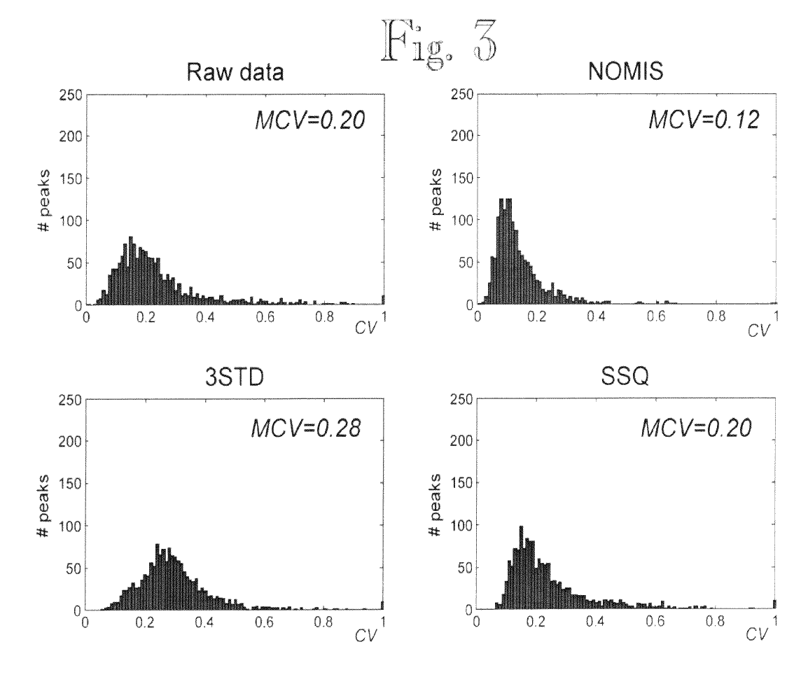

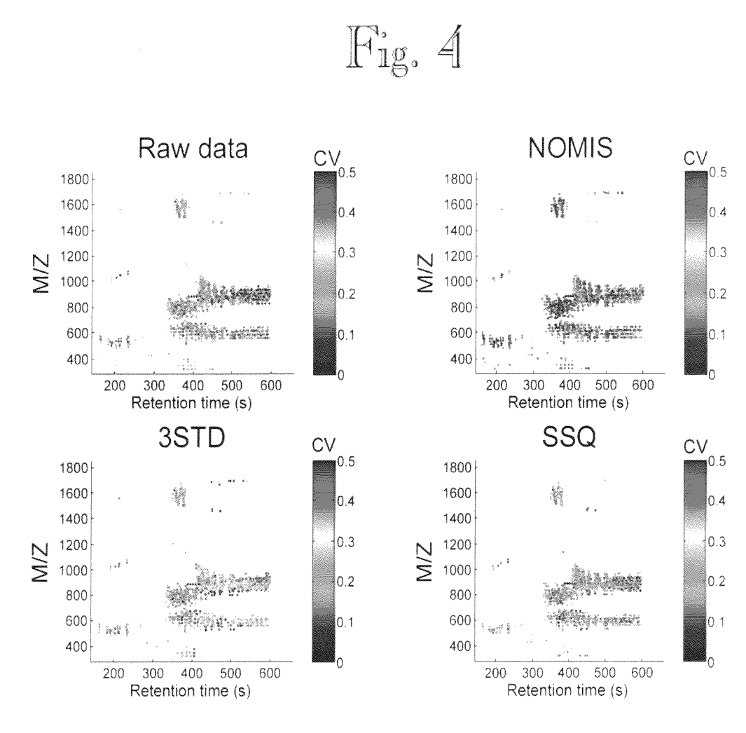

FIG. 3 shows a coefficient of variance distributions for different normalization methods. The data shown in FIG. 3 is based on mouse liver repeatability and reproducibility run of 16 samples (3 extractions from the same biological sample, each with repeated runs of 10, 3, and 3 injections, respectively). A total of 1470 monoisotopic peaks were included in the analysis. The technique according to the invention, which is denoted by symbol “NOMIS” and placed in the upper-right hand corner of FIG. 3, produces a notably narrower distribution of coefficient of variation (CV) as well as a lower median CV than do raw data and other normalization methods.

FIG. 4 shows coefficients of variance for individual peaks in a liver repeatability study. Each detected peak is shown in a two-dimensional plot of m/z vs. retention time plot, with colour corresponding to the coefficient of variance. Again, the result of the inventive technique is denoted by symbol “NOMIS” and placed in the upper-right hand corner of FIG. 4. This technique performs notably better than the other techniques in its ability to reduce the variability across the full spectrum. The 3STD method performs particularly poorly for higher retention times, where the normalization is based on triacylglycerol standard, which was found variable. See also Table 1 (tables are presented near the end of this description.

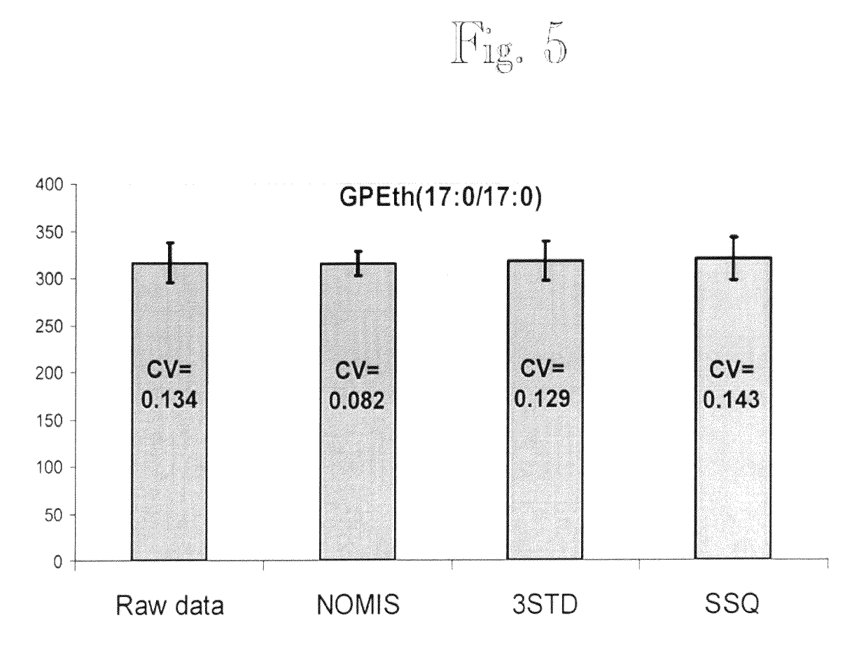

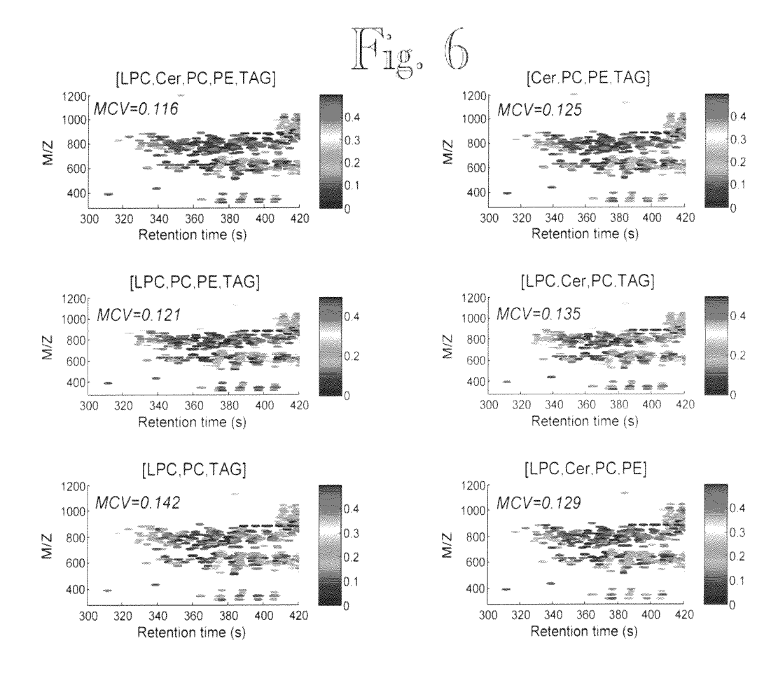

FIG. 5 shows a coefficient of variation for an internal standard (GPEth(17:0/17:0)) profile upon its addition to a raw dataset. The NOMIS method therefore utilized only four internal standards. While none of the method produces significant deviation in intensity, the NOMIS method leads to the lowest variability of the component.

FIG. 6 illustrates the inventive technique as a tool for selecting an optimal set of internal standards used normalization. The coefficients of variation for different combinations of internal standards used in the NOMIS method as applied to the liver dataset (1470 peaks). Only sub-region of m/z and retention times is shown, corresponding mainly to phospholipids, sphingolipids, and diacylglycerols.

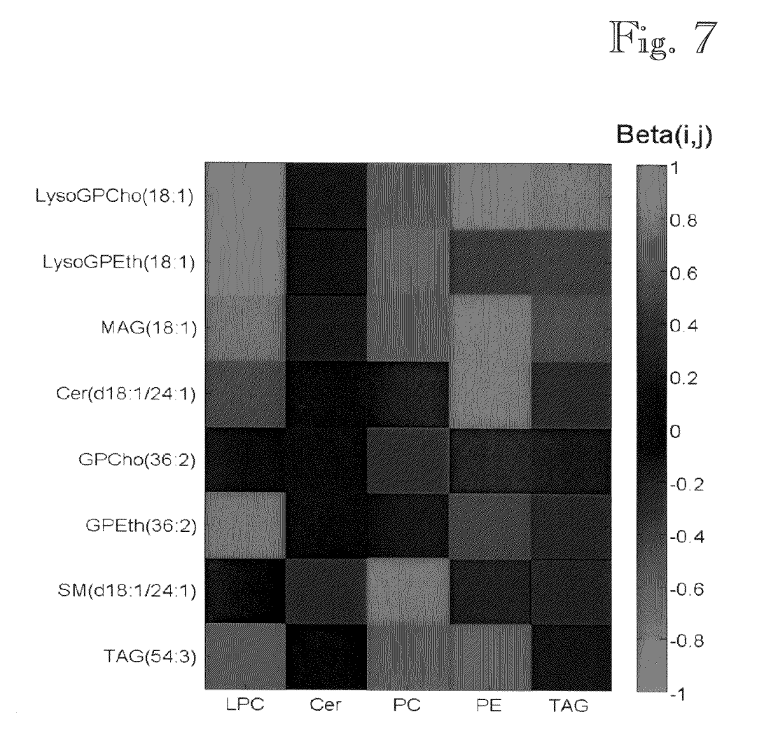

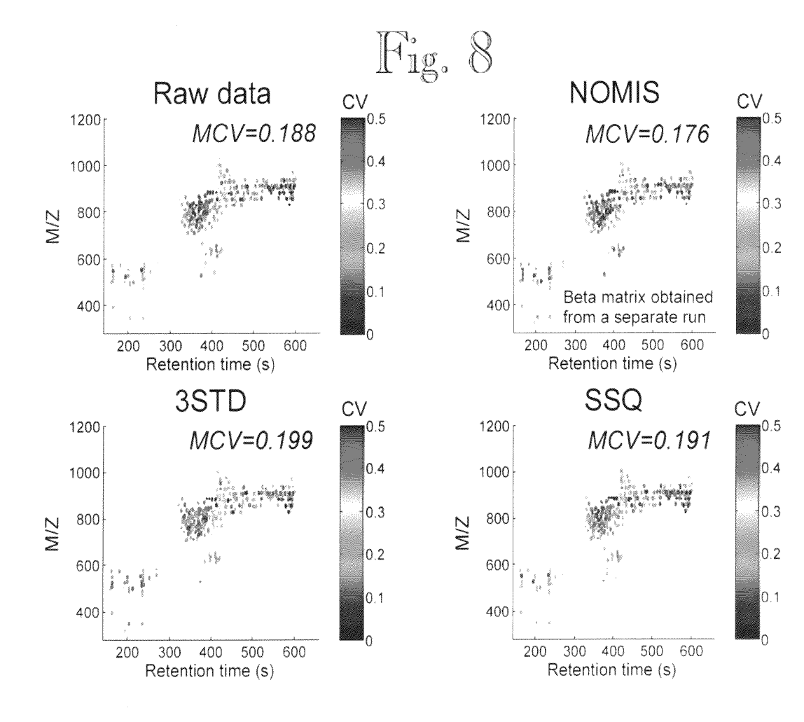

FIG. 7 shows the beta (β) matrix values for selected liver lipid components. The beta matrix values are shown for eight illustrative lipid molecular species of different functional class and for all internal standards used, which are abbreviated as shown in Table 1. The LPC has expectedly high influence on monoacyl lipids. Curiously, sphingomyelin, which does not have an internal standard of its own, is influenced most by ceramide and PC, as one would have expected based on chemical structure. The internal standard specific factor influencing the normalization is also proportional to the internal standard concentration.

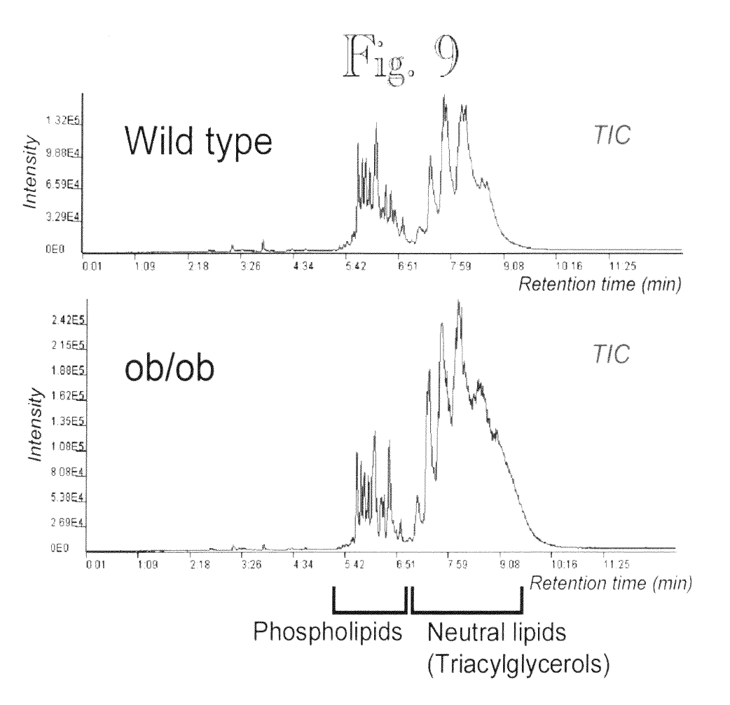

FIG. 8 shows coefficients of variance for identified liver lipid species. Each lipid molecular species is shown in the two dimensional plot of m/z vs. retention time plot, with the colour corresponding to the coefficient of variance. The data is based on normalization performed on a different biological sample as in FIG. 4, which was run nine times (three extractions with three injections each). A total of 360 identified lipid molecular species were included in the analysis. The NOMIS method utilized the Beta matrix calculated previously from a 16-sample run which was described in connection with FIGS. 3 and 4.

It is readily apparent to a person skilled in the art that, as the technology advances, the inventive concept can be implemented in various ways. The invention and its embodiments are not limited to the examples described above but may vary within the scope of the claims.

### SUMMARY

Success of metabolomics as a phenotyping platform largely depends on its ability to detect various sources of biological variability. Removal of platform-specific sources of variability such as systematic error is therefore one of the foremost priorities in data pre-processing. However, chemical diversity of molecular species included in typical metabolic profiling experiments leads to different responses to variations in experimental conditions, making normalization a very demanding task.

None of the described prior art normalization methods systematically take advantage of the obscuring variability that can be learned from the measured data itself. For example, monitoring multiple standard compounds across multiple sample runs may help determine how the standards are correlated, what variation is specific to a specific standard and what is common, and which patterns of variation are shared between the measured metabolites and the standards so they can be removed. In this paper we present such a new approach to normalization of metabolomic data aiming to address these issues, and develop a mathematical model that optimally assigns normalization factors for each metabolite measured based on internal standard profiles. This description demonstrates the inventive technique in the context of mouse liver lipid profiling using HPLC-MS, and compares its performance to two other commonly utilized approaches: normalization by sum of squares and by retention time region specific standard compounds.

Tables

TABLE 1

| | | | Reten- | | |
|---|---|---|---|---|---|
| Abbre- | | Amount | tion | Mean | |
| viation | Name | (μg/sample) | time (s) | intensity | CV |
| LPC | GPCho(17:0/0:0) | 6.408 | 210 | 5574 | 0.118 |
| Cer | Cer(d18:1/17:0) | 1.832 | 381 | 1044 | 0.197 |
| PC | GPCho(17:0/17:0) | 0.198 | 388 | 521 | 0.111 |
| PE | GPEth(17:0/17:0) | 1.790 | 392 | 316 | 0.134 |
| TAG | TG(17:0/17:0/17:0) | 2.072 | 543 | 202 | 0.335 |

TABLE 2

| | | | Internal |
|---|---|---|---|
| | Raw data | NOMIS | standard |
| Lysophosphatidylcholines (N = 13) | 0.245 | 0.094 | 0.221 |
| Phosphatidylcholines (N = 74) | 0.183 | 0.100 | 0.209 |
| Triacylglycerols (N = 184) | 0.227 | 0.146 | 0.308 |

### REFERENCES

Bijisma S, Bobeldijk I, Verheij E R, Ramaker R, Kochhar S, Macdonald I A, vanOmmen B, Smilde A K: Large-scale human metabolomics studies: A strategy for data (pre-) processing and validation. Anal. Chem. 2006, 78(2): 567-574.

1. A method for normalizing a plurality of spectra, the method comprising:
preparing (1-2) a plurality of experiment runs;
processing (1-4) each of the prepared experiment runs in an LC/MS spectrometer to obtain a spectrum in respect of each processed experiment run;
internally representing (1-10) each spectrum as a layout of mass/charge versus retention time;
performing a peak detection (1-12) to detect peaks of each spectrum;
internally aligning (1-14) the detected peaks of each spectrum; and
normalizing (1-18) the plurality of spectra, wherein the normalizing comprises modelling variation of Yᵢⱼ, denoted δYᵢⱼ, as a function of variability of Ω, denoted ƒ(δΩ);
wherein:
δ denotes variability of a quantity, wherein the variability is a measure of the quantity's deviation from an average value of the quantity over the sample runs;
X=Xᵢⱼ=intensity matrix for all peaks and X is mapped to Y via a first data transformation functions ƒ such that Y=ƒ¹(X);
Z=Zᵢⱼ=intensity matrix for internal standard peaks and Z is mapped to Ω via a second data transformation function t such that Ω=t⁻¹=(Z);
i denotes peaks: i→{m/z, rt} and i=1 . . . N;
j denotes experiment runs.

2. A method according to claim 1, wherein
δYᵢⱼ˜ΣᵢⱼβᵢₛδΩₛⱼ;
wherein s denotes peaks from internal standard compounds:
s→{m/z, rt} and s=1 . . . S and the parameters βᵢₛ control how the variability of internal standard intensities will affect the variability of intensities of other peaks.

3. A method according to claim 1, wherein
∥δYᵢⱼ=ƒ(δΩ)∥ is Gaussian.

4. A method according to claim 1, further comprising calculating normalization factors \tilde{X}ᵢⱼ for each peak such that the normalization factors are about equal to:
$${\tilde{X}}_{ij} = {X}_{ij} \times exp ( - {\sum }_{s} {β}_{is} ( {Ω}_{sj} - 〈 {Ω}_{s .} 〉 ) ) .$$

5. A method according to claim 1, wherein the spectra represent metabolite data.

6. A computer system for processing a plurality of spectra, the computer system comprising:
means for internally representing each spectrum as a layout of mass/charge versus retention time, each spectrum being obtained from an LC/MS spectrometer in respect of a specific experiment run;
means for performing a peak detection to detect peaks of each spectrum;
means for internally aligning the detected peaks of each spectrum; and
means for normalizing the plurality of spectra, wherein the normalizing comprises modelling variation of Yᵢⱼ, denoted δYᵢⱼ, as a function of variability of Ω, denoted ƒ(δΩ);
wherein:
δ denotes variability of a quantity, wherein the variability is a measure of the quantity's deviation from an average value of the quantity over the sample runs;
X=Xᵢⱼ=intensity matrix for all peaks and X is mapped to Y via a first data transformation function ƒ such that Y=f¹(X);
Z=Zᵢⱼ=intensity matrix for internal standard peaks and Z is mapped to Ω via a second data transformation function t such that Ω=t⁻¹(Z);
i denotes peaks: i→{m/z, rt} and i=1 . . . N; and
j denotes experiment runs.

7. A program product for a data processor, the program product comprising program code portions for causing the data processor to execute the normalization according to claim 1 when the program product is executed in the data processor.
